(19) United States
(12) Patent Application Publication
(10) Pub. No.: US 2005/0238318 A1
(43) Pub. Date: Oct. 27, 2005

(54) Recording and reproducing apparatus and recording method of the same

(75) Inventor: Satomi Watanabe, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/099,080

(22) Filed: Apr. 5, 2005

(30) Foreign Application Priority Data
Apr. 5, 2004 (JP) JP2004-110944

(51) Int. Cl. H04N 5/781

(52) U.S. Cl. 386/46; 386/126

(57) ABSTRACT

A recording and reproducing apparatus is constructed so that a bit rate at which video-audio data of timer reservation recording is recorded on a record medium is calculated based on a residual capacity of a record area of the record medium before the timer reservation recording and a residual capacity of the record area of the record medium after the timer reservation recording specified and the video-audio data of the timer reservation recording is recorded on the record medium based on the bit rate calculated.

### BACKGROUND OF THE INVENTION

1. Field of the Invention

The present invention relates to a recording and reproducing apparatus for recording and reproducing video-audio data on a record medium, and particularly to a recording and reproducing apparatus capable of recording video-audio data of a television broadcast program of timer reservation recording with a desired residual capacity left in a record area of a record medium.

2. Description of the Related Art

In the case of making timer reservation recording of video-audio data of a television broadcast program on a record medium such as a hard disk or an optical disk such as a DVD-R (Digital Versatile Disk-Recordable) or DVD-RW (Digital Versatile Disk-ReWritable), it has conventionally been constructed so that one of predetermined bit rates of XP (9.8 Mbps), SP (5 Mbps), LP (2.5 Mbps) modes, etc., is selected and the video-audio data of the television broadcast program of the timer reservation recording is recorded on the record medium. As a result of that, there was a problem that a desired residual capacity for recording another program cannot be left in a record area of the record medium after the video-audio data of the television broadcast program of the timer reservation recording is recorded on the record medium.

As background arts, there was an art constructed so that when a residual record capacity of a record medium is lacking for recording time of a video program and the extent of the lack is small, an index of the lack extent of the residual capacity is calculated and a bit rate is automatically changed so as to become lower than a standard bit rate by a predetermined ratio based on the index related to the lack extent of the residual capacity (for example, see JP-A-9-284715).

Also, there was an art constructed so that when a residual capacity is left in a record medium in the case of making recording at the minimum bit rate based on a residual capacity of the record medium and recording time of video-audio data, a target bit rate greater than the minimum bit rate is calculated so as to decrease the residual capacity of the record medium and the video-audio data is recorded at the bit rate calculated (for example, see JP-A-2001-28732).

### SUMMARY OF THE INVENTION

However, in the former of the background arts described above, when a residual record capacity of a record medium is lacking for recording time of a video program and the extent of the lack is small, an index of the lack extent of the residual capacity is calculated and a bit rate can be automatically changed so as to become lower than a standard bit rate by a predetermined ratio based on the index related to the lack extent of the residual capacity, but a problem that video-audio data of a television broadcast program of timer reservation recording cannot be recorded on the record medium with a desired residual capacity left in a record area of the record medium after the timer reservation recording was not solved.

Also, in the latter, when a residual capacity is left in a record medium in the case of making recording at the minimum bit rate based on a residual capacity of the record medium and recording time of video-audio data, a target bit rate greater than the minimum bit rate is calculated so as to decrease the residual capacity of the record medium and the video-audio data can be recorded at the bit rate calculated, but in a manner similar to the former, the problem that video-audio data of a television broadcast program of timer reservation recording cannot be recorded on the record medium with a desired residual capacity left in a record area of the record medium after the timer reservation recording was not solved.

The invention is implemented in view of such a problem which the background arts have, and an object of the invention is to provide a recording and reproducing apparatus capable of recording video-audio data of a television broadcast program of timer reservation recording on a record medium with a desired residual capacity left in a record area of the record medium after the timer reservation recording.

In order to achieve the object, the invention provides a recording and reproducing apparatus for recording and reproducing video-audio data on a record medium, including: residual capacity specification means for specifying a residual capacity of a record area of the record medium after timer reservation recording; recording time calculation means for calculating recording time of the video-audio data of the timer reservation recording; residual capacity calculation means for calculating a residual capacity of the record area of the record medium before the timer reservation recording; bit rate calculation means for calculating a bit rate at which the video-audio data of the timer reservation recording of the recording time calculated by the recording time calculation means is recorded on the record medium based on the residual capacity of the record area of the record medium before the timer reservation recording calculated by the residual capacity calculation means and the residual capacity of the record area of the record medium after the timer reservation recording specified by the residual capacity specification means; and recording means for recording the video-audio data of the timer reservation recording on the record medium based on the bit rate calculated by the bit rate calculation means.

The recording means could be constructed so as to record the video-audio data of the timer reservation recording on the record medium at the bit rate calculated by the bit rate calculation means when the bit rate calculated by the bit rate calculation means is a bit rate within a variable range.

The recording means could be constructed so as to record the video-audio data of the timer reservation recording on the record medium at the minimum bit rate when the bit rate calculated by the bit rate calculation means is the minimum bit rate or less.

By these means, the video-audio data of the television broadcast program of the timer reservation recording can be recorded on the record medium with a desired residual capacity left in the record area of the record medium after the timer reservation recording.

According to a recording and reproducing apparatus in accordance with a first aspect of the invention, it is constructed so that a bit rate at which video-audio data of timer reservation recording is recorded on a record medium is calculated based on a residual capacity of a record area of the record medium before the timer reservation recording and a residual capacity of the record area of the record medium after the timer reservation recording specified and the video-audio data of the timer reservation recording is recorded on the record medium at the bit rate calculated when the bit rate calculated is a bit rate within a variable range and the video-audio data of the timer reservation recording is recorded on the record medium at the minimum bit rate when the bit rate calculated is the minimum bit rate or less, so that video-audio data of a television broadcast program of timer reservation recording is recorded on the record medium at the bit rate of the variable range and a desired residual capacity can be left in the record area of the record medium after the timer reservation recording and also when the desired residual capacity cannot be left in the record area of the record medium, the video-audio data of the television broadcast program of the timer reservation recording can be recorded on the record medium at the minimum bit rate.

According to a recording and reproducing apparatus in accordance with a second aspect of the invention, it is constructed so that a bit rate at which video-audio data of timer reservation recording is recorded on a record medium is calculated based on a residual capacity of a record area of the record medium before the timer reservation recording and a residual capacity of the record area of the record medium after the timer reservation recording specified and the video-audio data of the timer reservation recording is recorded on the record medium based on the bit rate calculated, so that the video-audio data of the television broadcast program of the timer reservation recording can be recorded on the record medium with a desired residual capacity left in the record area of the record medium.

According to a recording and reproducing apparatus in accordance with a third aspect of the invention, it is constructed so as to record video-audio data of timer reservation recording on a record medium at a bit rate calculated when the bit rate calculated is a bit rate within a variable range, so that video-audio data of a television broadcast program of timer reservation recording is recorded on the record medium at the bit rate of the variable range and a desired residual capacity can be left in the record area of the record medium after the timer reservation recording.

According to a recording and reproducing apparatus in accordance with a fourth aspect of the invention, it is constructed so as to record video-audio data of timer reservation recording on a record medium at the minimum bit rate when the bit rate calculated is the minimum bit rate or less, so that the video-audio data of the television broadcast program of the timer reservation recording can be recorded on the record medium at the minimum bit rate when a desired residual capacity cannot be left in a record area of the record medium.

According to a recording method in accordance with a fifth aspect of the invention, it is constructed so that a bit rate at which video-audio data of timer reservation recording is recorded on a record medium is calculated based on a residual capacity of a record area of the record medium before the timer reservation recording and a residual capacity of the record area of the record medium after the timer reservation recording specified and the video-audio data of the timer reservation recording is recorded on the record medium at the bit rate calculated when the bit rate calculated is a bit rate within a variable range and the video-audio data of the timer reservation recording is recorded on the record medium at the minimum bit rate when the bit rate calculated is the minimum bit rate or less, so that video-audio data of a television broadcast program of timer reservation recording is recorded on the record medium at the bit rate of the variable range and a desired residual capacity can be left in the record area of the record medium after the timer reservation recording and also when the desired residual capacity cannot be left in the record area of the record medium, the video-audio data of the television broadcast program of the timer reservation recording can be recorded on the record medium at the minimum bit rate.

### BRIEF DESCRIPTION OF THE DRAWINGS

FIG. 1 is a block diagram showing a configuration of a recording and reproducing apparatus of one embodiment of the invention;

FIG. 2 is an explanatory diagram showing one example of a setting screen of timer reservation recording of the recording and reproducing apparatus of one embodiment of the invention;

FIGS. 3A to 3C are explanatory diagrams schematically showing a record state of a record area of an optical disk of the recording and reproducing apparatus of one embodiment of the invention; and

FIG. 4 is a flowchart showing an operation of the recording and reproducing apparatus of one embodiment of the invention.

### DETAILED DESCRIPTION OF THE PREFFERED EMBODIMENTS

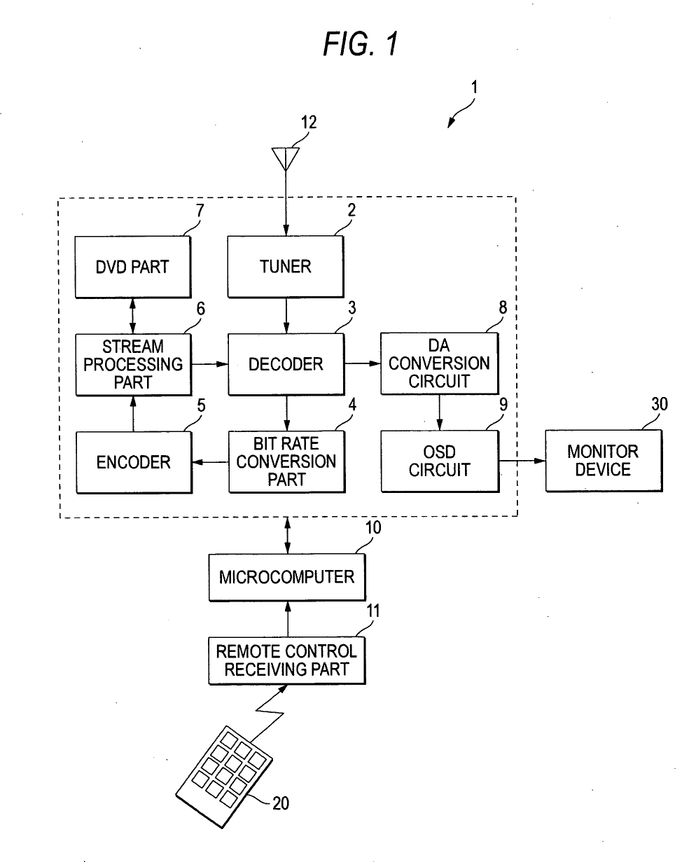

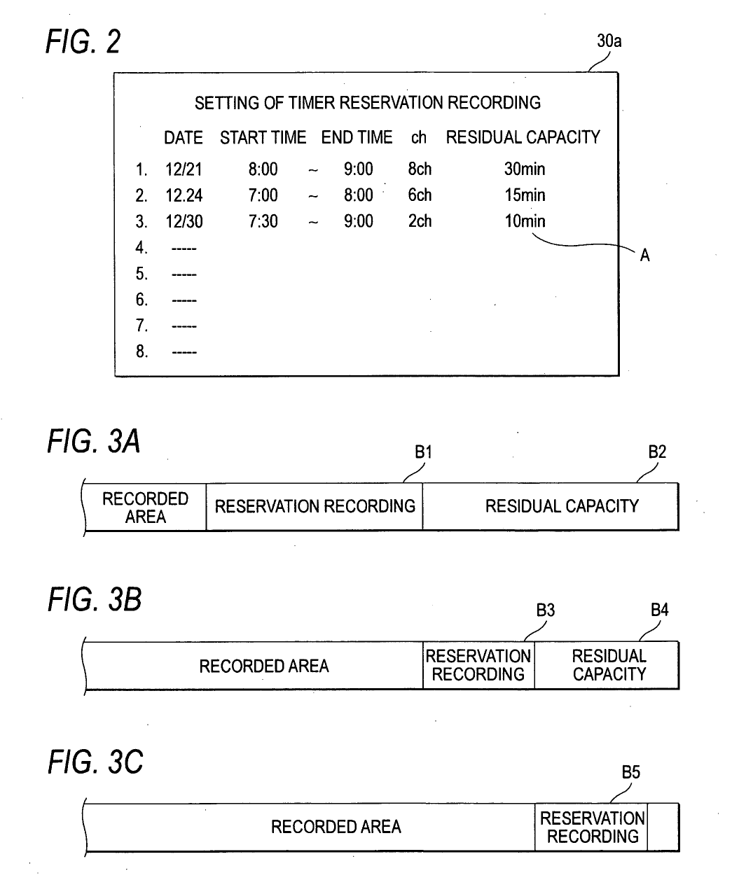

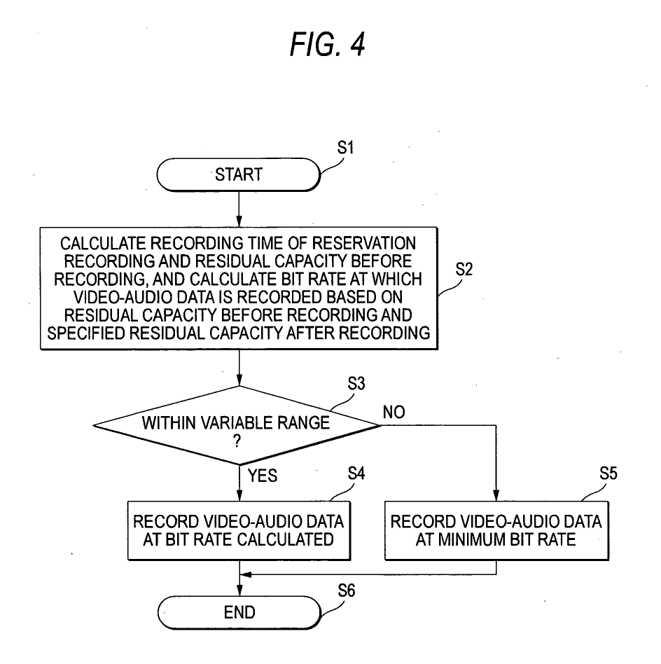

The best mode for carrying out the invention will be described below in detail with reference to the drawings properly. FIG. 1 is a block diagram showing a configuration of a recording and reproducing apparatus of one embodiment of the invention, FIG. 2 is an explanatory diagram showing one example of a setting screen of timer reservation recording of the recording and reproducing apparatus of one embodiment of the invention, FIGS. 3A to 3C are explanatory diagrams schematically showing a record state of a record area of an optical disk of the recording and reproducing apparatus of one embodiment of the invention, and FIG. 4 is a flowchart showing an action of the recording and reproducing apparatus of one embodiment of the invention.

First, description will be made based on the block diagram showing the configuration of the recording and reproducing apparatus of one embodiment of the invention of FIG. 1. A recording and reproducing apparatus 1 includes a tuner 2 for receiving television broadcast of digital broadcast of a channel selected from television broadcast radio waves received by an antenna 12, a decoder 3 for expanding video-audio data of a digital signal compressed by an MPEG method and decoding the video-audio data of the digital signal, a bit rate conversion part 4 for converting a bit rate of the video-audio data of the digital signal, an encoder 5 for compressing and encoding the video-audio data of the digital signal by the MPEG method, a stream processing part 6 for performing stream processing of multiplexing, demultiplexing, time stamp processing of the video-audio data of the digital signal, a DVD part 7 for recording and reproducing the video-audio data of the digital signal on an optical disk such as a DVD-R or a DVD-RW, a DA (Digital-Analog) conversion circuit 8 for converting the video-audio data of the digital signal into a video-audio signal of an analog signal, an OSD (On-Screen Character Display) circuit 9 for superimposing a character information signal on a video signal and displaying character information on a screen of a monitor device 30, a microcomputer 10 for controlling the whole system of the recording and reproducing apparatus 1, and a remote control receiving part 11 for receiving a remote control signal sent from a remote controller 20 and converting the remote control signal into a predetermined electrical signal.

An operation of the recording and reproducing apparatus configured as described above will be described below.

When display of a menu screen is commanded by a key operation of the remote controller 20, a remote control signal of an infrared signal is sent from the remote controller 20 and the remote control signal of the infrared signal sent is received by the remote control receiving part 11 and is converted into a predetermined electrical signal and is sent to the microcomputer 10. When display of a menu screen is commanded by a key operation of the remote controller 20, the microcomputer 10 sends a character information signal and a control signal to the OSD circuit 9, and displays the menu screen on a screen of the monitor device 30 (not shown). Then, when setting of timer reservation recording of the menu screen displayed on the monitor device 30 is selected by a key operation of the remote controller 20, the microcomputer 10 sends a character information signal and a control signal to the OSD circuit 9, and displays a setting screen of the timer reservation recording on a screen 30a of the monitor device 30 (see FIG. 2). When reservation recording dates of television broadcast programs of timer reservation recording, recording start times, recording end times, broadcast channels and residual capacities A, in which video-audio data can be recorded at a standard bit rate, left in a record area of the optical disk after the timer reservation recording (see FIG. 2) are set and the timer reservation recording is reserved by a key operation of the remote controller 20, the microcomputer 10 stores the set timer reservation recording in built-in memory of the microcomputer 10.

In the case of reaching the recording date and the recording start time of a television broadcast program in which timer reservation recording is set, the microcomputer 10 sends a control signal to the tuner 2 and a television broadcast of a channel selected from television broadcast radio waves received by the antenna 12 is received and a control signal is sent to the decoder 3, the bit rate conversion part 4, the encoder 5 and the stream processing part 6 and video-audio data of the received television broadcast program is decoded and is converted into a predetermined bit rate and the video-audio data converted into the predetermined bit rate is compressed and encoded by an MPEG method and an encoded video-audio signal is multiplexed and is recorded on the optical disk of the DVD part 7. When the video-audio data of the television broadcast program is recorded on the optical disk, the microcomputer 10 calculates recording time ranging from the recording start time to the recording end time of the television broadcast program of the timer reservation recording and a residual capacity of a record area of the optical disk mounted in the DVD part 7 before the timer reservation recording and based on the residual capacity of the record area of the optical disk before the timer reservation recording and a residual capacity of the record area of the optical disk after the timer reservation recording specified, a bit rate at which the video-audio data of the television broadcast program of the recording time calculated is recorded on the optical disk is calculated and based on the bit rate calculated, the video-audio data of the television broadcast program of the timer reservation recording is recorded on the optical disk mounted in the DVD part 7.

The bit rate at which the video-audio data is recorded on the optical disk will be described below. In the following description, the case that a standard bit rate at which video-audio data is recorded on an optical disk is set at 10 Mbps and the minimum bit rate is set at 1 Mbps and the bit rate is variable within the range from 10 Mbps to 1 Mbps will be described. In the case of reserving timer reservation recording for specifying that a residual capacity in which video-audio data of 30 minutes can be recorded at the standard bit rate is left in a record area of the optical disk after video-audio data of a television broadcast program with recording time of 60 minutes is recorded on the optical disk when video-audio data has already been recorded in a record area of the optical disk and a residual capacity of the record area of the optical disk is 4.50 GB (see FIG. 2, timer reservation recording 1), it is constructed so that a residual capacity of 2.25 GB (=10 Mbps'30 minutes) of a storage area of the optical disk in which the video-audio data of 30 minutes can be recorded at the standard bit rate of 10 Mbps and a bit rate of 5 Mbps (=(4.50 GB-2.25 GB)/60 minutes) at which the video-audio data of the television broadcast program with recording time of 60 minutes is recorded on the optical disk are calculated and video-audio data B1 of the television broadcast program of the timer reservation recording is recorded on the optical disk at the bit rate calculated and a residual capacity B2 of the record area is left in the record area of the optical disk (see FIG. 3A).

Also, in the case of reserving timer reservation recording for specifying that a residual capacity in which video-audio data of 15 minutes can be recorded at the standard bit rate is left in a record area of the optical disk after video-audio data of a television broadcast program with recording time of 60 minutes is recorded on the optical disk when a residual capacity of the record area of the optical disk is 2.25 GB (see FIG. 2, timer reservation recording 2), it is constructed so that a residual capacity of 1.13 GB (=10 Mbps×15 minutes) of a storage area of the optical disk in which the video-audio data of 15 minutes can be recorded at the standard bit rate of 10 Mbps and a bit rate of 2.5 Mbps (=(2.25-1.13)/60 minutes) at which the video-audio data of the television broadcast program with recording time of 60 minutes is recorded are calculated and video-audio data B3 of the television broadcast program of the timer reservation recording is recorded on the optical disk at the bit rate calculated and a residual capacity B4 is left in the record area of the optical disk (see FIG. 3B).

Also, in the case of reserving timer reservation recording for specifying that a residual capacity in which video-audio data of 10 minutes can be recorded at the standard bit rate is left in a record area of the optical disk after video-audio data of a television broadcast program with recording time of 90 minutes is recorded on the optical disk when a residual capacity of the record area of the optical disk is 1.13 GB (see FIG. 2, timer reservation recording 3), when a residual capacity of 0.75 GB (=10 Mbps×10 minutes) in which the video-audio data of 10 minutes can be recorded at the standard bit rate of 10 Mbps and a bit rate of 0.56 Mbps (=(1.13GB-0.75 GB)/90 minutes) at which the video-audio data of the television broadcast program with recording time of 90 minutes is recorded are calculated, the calculated bit rate becomes less than or equal to a bit rate within a variable range and becomes smaller than the minimum bit rate of 1 Mbps, so that video-audio data B5 of the television broadcast program in which the timer reservation recording is set is recorded on the optical disk at the minimum bit rate of 1 Mbps (see FIG. 3C). After the timer reservation recording, a capacity of 3.64 GB (=1.13 GB-1 Mbps'90 minutes) is left in the record area of the optical disk.

Also, description will be made based on a flowchart showing an action of the recording and reproducing apparatus of one embodiment of the invention of FIG. 4.

In the case of reaching the recording date and the recording start time of a television broadcast program in which timer reservation recording is set, the flowchart proceeds from step S1 to step S2, and recording time ranging from the recording start time to the recording end time of the television broadcast program of the timer reservation recording and a residual capacity of a record area of the optical disk before the timer reservation recording are calculated and based on the residual capacity of the record area of the optical disk before the timer reservation recording and a residual capacity of the record area of the optical disk after the timer reservation recording specified, a bit rate at which the video-audio data of the television broadcast program of the recording time calculated is recorded on the optical disk is calculated and the flowchart proceeds to step S3.

In step S3, it is decided whether or not the bit rate calculated is a bit rate within a variable range, and when the bit rate calculated is the bit rate within the variable range, the flowchart proceeds to step S4 and when the bit rate calculated is not the bit rate within the variable range and is the minimum bit rate or less, the flowchart proceeds to step S5.

In step S4, video-audio data of the television broadcast program of the timer reservation recording is recorded on the optical disk at the bit rate calculated, and the flowchart proceeds to step S6 and the processing is ended.

In step S5, video-audio data of the television broadcast program of the timer reservation recording is recorded on the optical disk at the minimum bit rate, and the flowchart proceeds to step S6 and the processing is ended.

The best mode for carrying out the invention has been described above in detail, but the invention is not limited to this, and the changes or modifications can be made within a common knowledge of a person skilled in the art. For example, the case of making reservation recording of a television broadcast program with a desired residual capacity left in a record area of an optical disk using the optical disk as a record medium has been described, but it may be constructed so that reservation recording of a television broadcast program is made with a desired residual capacity left in a record area of a hard disk.

Incidentally, the microcomputer 10 functions as residual capacity specification means, as recording time calculation means, as residual capacity calculation means, as bit rate calculation means, and as recording means, partly or entirely in the above embodiment.

1. A recording and reproducing apparatus for recording and reproducing video-audio data on a record medium, comprising:
residual capacity specification means for specifying a residual capacity of a record area of the record medium after timer reservation recording;
recording time calculation means for calculating recording time of the video-audio data of the timer reservation recording;
residual capacity calculation means for calculating a residual capacity of the record area of the record medium before the timer reservation recording;
bit rate calculation means for calculating a bit rate at which the video-audio data of the timer reservation recording of the recording time calculated by the recording time calculation means is recorded on the record medium based on the residual capacity of the record area of the record medium before the timer reservation recording calculated by the residual capacity calculation means and the residual capacity of the record area of the record medium after the timer reservation recording specified by the residual capacity specification means; and
recording means for recording the video-audio data of the timer reservation recording on the record medium at the bit rate calculated by the bit rate calculation means when the bit rate calculated by the bit rate calculation means is a bit rate within a variable range and recording the video-audio data of the timer reservation recording on the record medium at a minimum bit rate when the bit rate calculated by the bit rate calculation means is the minimum bit rate or less.

2. A recording and reproducing apparatus for recording and reproducing video-audio data on a record medium, comprising:
residual capacity specification means for specifying a residual capacity of a record area of the record medium after timer reservation recording;
recording time calculation means for calculating recording time of the video-audio data of the timer reservation recording;
residual capacity calculation means for calculating a residual capacity of the record area of the record medium before the timer reservation recording;
bit rate calculation means for calculating a bit rate at which the video-audio data of the timer reservation recording of the recording time calculated by the recording time calculation means is recorded on the record medium based on the residual capacity of the record area of the record medium before the timer reservation recording calculated by the residual capacity calculation means and the residual capacity of the record area of the record medium after the timer reservation recording specified by the residual capacity specification means; and
recording means for recording the video-audio data of the timer reservation recording on the record medium based on the bit rate calculated by the bit rate calculation means.

3. The recording and reproducing apparatus as claimed in claim 2, wherein the recording means is recording means for recording the video-audio data of the timer reservation recording on the record medium at the bit rate calculated by the bit rate calculation means when the bit rate calculated by the bit rate calculation means is a bit rate within a variable range.

4. The recording and reproducing apparatus as claimed in claim 2, wherein the recording means is recording means for recording the video-audio data of the timer reservation recording on the record medium at a minimum bit rate when the bit rate calculated by the bit rate calculation means is the minimum bit rate or less.

5. A recording method of a recording and reproducing apparatus for recording and reproducing video-audio data on a record medium, comprising the steps of:
calculating recording time of the video-audio data of timer reservation recording;
calculating a residual capacity of the record area of the record medium before the timer reservation recording;
calculating a bit rate at which the video-audio data of the timer reservation recording of the recording time calculated is recorded on the record medium based on the residual capacity of the record area of the record mediumbefore the timer reservation recording calculated and the residual capacity of the record area of the record medium after the timer reservation recording specified;
recording the video-audio data of the timer reservation recording on the record medium at the bit rate calculated when the bit rate calculated is a bit rate within a variable range or at a minimum bit rate when the bit rate calculated is the minimum bit rate or less.
